(19) United States
(12) Patent Application Publication
(10) Pub. No.: US 2025/0269688 A1
(43) Pub. Date: Aug. 28, 2025

(54) ASYMMETRIC HUB BEARING UNIT

(71) Applicant: AKTIEBOLAGET SKF, GOTEBORG (SE)

(72) Inventors: Fabio BOGLIACINO, Corneliano d’Alba (IT); Alessandro FERRERO, Torino (IT); Paolo A RE, Nichelino (IT)

(21) Appl. No.: 19/057,401

(22) Filed: Feb. 19, 2025

(30) Foreign Application Priority Data
Feb. 26, 2024 (IT) 102024000004012

(51) Int. Cl. B60B 27/00; B60B 27/02; F16C 33/58

(52) U.S. Cl. CPC B60B 27/0094; B60B 27/0005; B60B 27/02; F16C 33/583; B60B 2380/12; B60B 2380/75

(57) ABSTRACT

A hub bearing unit includes a hub rotatable about a central axis and has outboard and inboard inner raceways. An outer ring is disposed about the hub and is connectable with a vehicle, the outer ring having outboard and inboard outer raceways. An outboard set of rolling elements is disposed between the outboard inner and outer raceways, traverses an outboard pitch circle and has an outboard contact angle. An inboard set of rolling elements is disposed between the inboard inner and outer raceways, traverses an inboard pitch circle and has an inboard contact angle. The outboard pitch circle has a diameter at least five millimeters greater than a diameter of the inboard pitch circle. The outboard contact angle is at least thirty-four degrees and the inboard contact angle has a value within a range of forty-five percent and seventy-five percent of the value of the outboard contact angle.

### CROSS-REFERENCE

This application claims priority to Italian patent application no. 102024000004012 filed on Feb. 26, 2024, the entire contents of which are fully incorporated herein by reference.

### BACKGROUND OF THE INVENTION

The present invention relates to bearings, and more particularly to hub bearing units.

Wheel hub bearing units are generally known in the bearing and automotive industries and are used to rotatably couple wheels to vehicles such as automobiles and trucks. A hub bearing unit typically includes a cylindrical hub connectable with an axle, an outer ring disposed about the hub, and one or more rows or sets of rolling elements disposed between the hub and the outer ring. In certain constructions, the hub is rotatable about a central axis and includes a radial flange adapted to receive a wheel and the outer ring is fixedly connected with the vehicle, either to a steering knuckle or suspension component. In other configurations, the hub is mounted to a fixed shaft and the outer ring rotates about a central axis through the shaft and has a flange adapted to receive a wheel.

With either basic structure, the hub bearing unit ordinarily includes two sets or rows of rolling elements, which may be balls, cylindrical rollers, tapered rollers, or any other appropriate type of rolling elements. When designing a wheel hub bearing unit for a specific application, consideration must be given to minimizing friction, providing sufficient structural rigidity to reliably support all anticipated loading, and reducing mass and space requirements for assembly into a vehicle. More specifically, wheel bearing units are typically designed to provide adequate stiffness to the suspension system, while minimizing the friction or drag. These two requirements are normally in conflict, as designing the hub unit to increase stiffness often causes an increase in friction and conversely, a design which decreases friction typically results in a reduction in stiffness. As such, most designs of hub bearing units are compromises between the two factors.

Typically, the balance between these factors has been solved by sizing the two rows of rolling elements such that the pitch diameter of one row is slightly larger than the other row, known as an asymmetrical configuration, and there is a small difference between the contact angles of each row. In such balanced designs, small changes to the inboard contact angle have significant impact on friction, i.e., when there is an increase of the inboard contact angle to increase stiffness, the friction within the hub bearing unit significantly increases. To reduce the effect of increased friction, manufacturers often resort to additional treatment of the raceway surfaces and/or increased lubrication to the raceways, both solutions increasing the cost of the hub bearing unit. An alternative or additional solution is to provide low drag seals to reduce the friction effects of the seals, but such seals may lead to a decrease in sealing performance.

### SUMMARY OF THE INVENTION

The present invention is a hub bearing unit for rotatably coupling a wheel with a vehicle, the wheel being rotatable about a central axis. The hub bearing unit comprises a hub rotatable about the central axis and having an inboard axial end and an outboard axial end, a flange extending radially outwardly from a remainder of the hub at least generally adjacent to the outboard axial end and configured to mount the wheel to the hub, an outboard inner raceway and an inboard inner raceway spaced axially from the outboard inner raceway. An outer ring is disposed about the hub and is configured to connect with the vehicle, the outer ring having an outboard outer raceway and an inboard outer raceway spaced axially from the outboard outer raceway. An outboard set of rolling elements, which are preferably balls, is disposed between the outboard inner raceway and the outboard outer raceway so as to traverse an outboard pitch circle having a pitch diameter. Each rolling element of the outboard set of rolling elements contacts the outboard inner raceway at an inner contact point and contacts the outboard outer raceway at an outer contact point. A line extending through the inner and outer contact points defines an outboard contact angle with a line perpendicular to the central axis.

Further, an inboard set of rolling elements, which are also preferably balls, is disposed between the inboard inner raceway and the inboard outer raceway so as to traverse an inboard pitch circle having an inboard pitch diameter, the outboard pitch diameter being at least five millimeters greater than the inboard pitch diameter. Each rolling element of the inboard set of rolling elements contacts the inboard inner raceway at an inner contact point and contacts the inboard outer raceway at an outer contact point. A line extending through the inner and outer contact points defines an inboard contact angle with a line perpendicular to the central axis. To optimize the performance of the hub bearing unit, the outboard contact angle has a value of at least thirty-four degrees and the inboard contact angle has a value within a range of forty-five percent and seventy-five percent of the value of the outboard contact angle.

Furthermore, each line extending through the inner contact point and the outer contact point of each rolling element of the outboard set of rolling elements intersects the central axis at an outboard pressure center. The outboard pressure center is spaced axially from the outboard pitch circle by an outboard pressure center spacing distance. Also, each line extending through the inner contact point and the outer contact point of each rolling element of the inboard set of rolling elements intersects the central axis at an inboard pressure center. The inboard pressure center is spaced axially from the inboard pitch circle by an inboard pressure center spacing distance. For further optimization of the bearing unit, the inboard pressure center spacing distance has a value within a range of fifty percent and seventy percent of a value of the outboard pressure center spacing distance.

Preferably, the outboard pressure center is spaced axially from the outboard axial end of the flange by a distance of no greater than one and one-half millimeters (1.5 mm). The inboard pressure center is axially spaced from the inboard axial end of the outer ring by a distance of no greater than three millimeters (3 mm).

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is an axial cross-sectional view of a hub bearing unit of the present invention;

FIG. 2 is an axial cross-sectional view of a hub of the hub bearing unit;

FIG. 3 is an axial cross-sectional view of an outer ring of the hub bearing unit;

FIG. 4 is an axial cross-sectional view of an upper portion of the hub bearing unit;

FIG. 5 is a broken-away, enlarged axial cross-sectional view of a portion of FIG. 4, showing the outboard raceways of the hub bearing unit; and

FIG. 6 is a broken-away, enlarged axial cross-sectional view of another portion of FIG. 4, showing the inboard raceways of the hub bearing unit

### DETAILED DESCRIPTION OF THE INVENTION

Certain terminology is used in the following description for convenience only and is not limiting. The words “inner”, “inwardly” and “outer”, “outwardly” refer to directions toward and away from, respectively, a designated centerline or a geometric center of an element being described, the particular meaning being readily apparent from the context of the description. Further, as used herein, the words “connected” and “coupled” are each intended to include direct connections between two members without any other members interposed therebetween and indirect connections between members in which one or more other members are interposed therebetween. The terminology includes the words specifically mentioned above, derivatives thereof, and words of similar import.

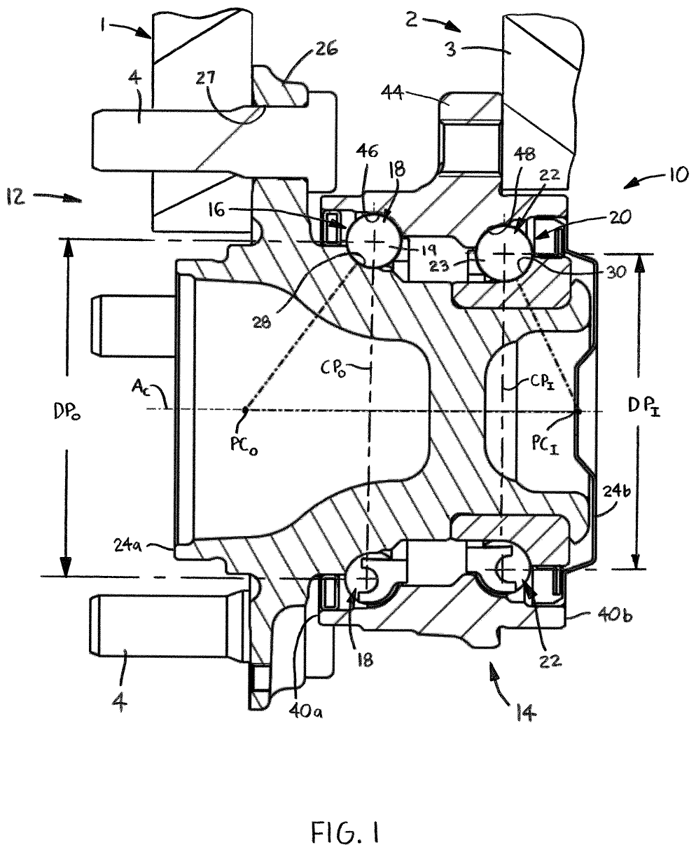

Referring now to the drawings in detail, wherein like numbers are used to indicate like elements throughout, there is shown in FIGS. 1-6 a hub bearing unit 10 for rotatably coupling a wheel 1 with a vehicle 2, specifically a steering knuckle or a suspension component 3, the wheel 1 being rotatable about a central axis A_{C}. The wheel hub bearing unit 10 basically comprises a hub 12 rotatable about the central axis A_{C}, an outer ring 14 disposed about the hub 12, an outboard set 16 of rolling elements 18 and an inboard set 20 of rolling elements 22 each disposed between and rotatably coupling the hub 12 and the outer ring 14. The hub 12 and the outer ring 14 are configured, i.e., constructed, assembled, etc., and the rolling elements 18, 22 are sized, so as to position the rolling elements 18, 22 in locations which optimize the performance of the hub bearing unit 10, as discussed in detail below.

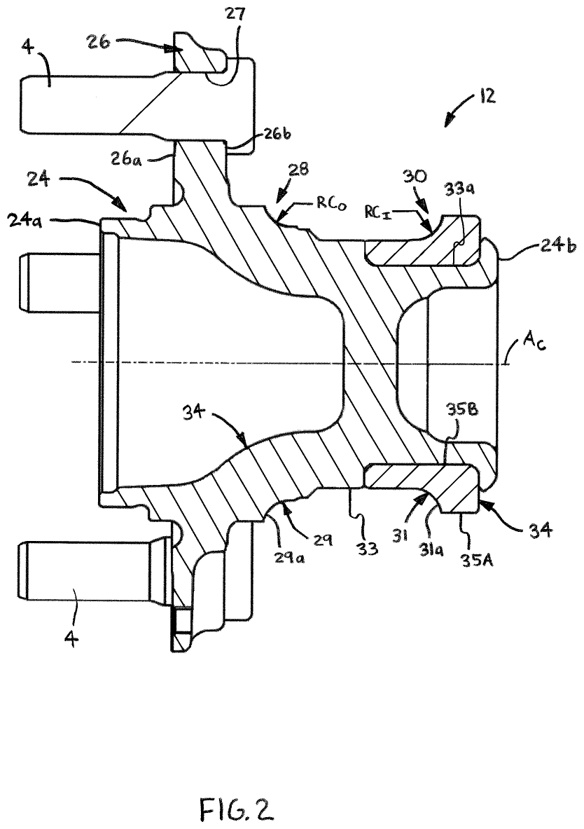

Referring particularly to FIG. 2, the hub 12 includes a generally cylindrical body 24 having an outboard axial end 24a, an opposing inboard axial end 24b and an annular flange 26 extending radially outwardly from a remainder of the body 24 at least generally adjacent to the outboard end 24a. The hub flange 26 is configured to mount the wheel 1 to the hub 12, preferably by means of a plurality of fasteners 4 extending through holes 27 in the flange 26, and has an outboard axial end 26a and an inboard axial end 26b. Further, the hub body 24 has an outboard inner raceway 28 and an inboard inner raceway 30 spaced axially from the outboard inner raceway 28. Preferably, the hub cylindrical body 24 includes or is formed of a main body portion 32 including the annular flange 26 and having an outer circumferential surface 33, and an annular ring 34 disposed about the main body portion 32 adjacent to the inboard axial end 24b. Specifically, the outboard inner raceway 28 is formed in the outer circumferential surface 33 of the main body portion 32 and the annular ring 34 has an outer circumferential surface 35A including the inboard inner raceway 30 and an inner circumferential surface 35B disposed about a section of the outer surface 33 of the main body portion 32.

Preferably, the outboard inner raceway 28 is formed as first concave annular groove 29 extending radially inwardly from the outer circumferential surface 33B of the hub main body portion 32. Similarly, the inboard inner raceway 30 is preferably formed as a second concave annular groove 31 extending radially inwardly from the outer circumferential 35B of the annular ring 34. With such concave annular grooves 29, 31, the inner raceways 28, 30 are configured to receive rolling elements 18, 22 that are formed as balls 19, 23, respectively, as described below. However, one or both inner raceways 28, 30 may alternatively be formed as a flat annular groove for cylindrical or needle rollers, as frustoconical annular grooves for tapered rollers, or in any other appropriate manner for a specific application (no alternatives shown). Furthermore, each concave annular groove 29, 31 of the hub 12 preferably has a radial section 29a, 31a, respectively, with the radial section 29a of the outboard concave annular groove 29 facing toward the hub body inboard end 24b and the radial section 31a of the inboard concave annular groove 31 facing toward the hub body outboard end 24a, for reasons discussed below.

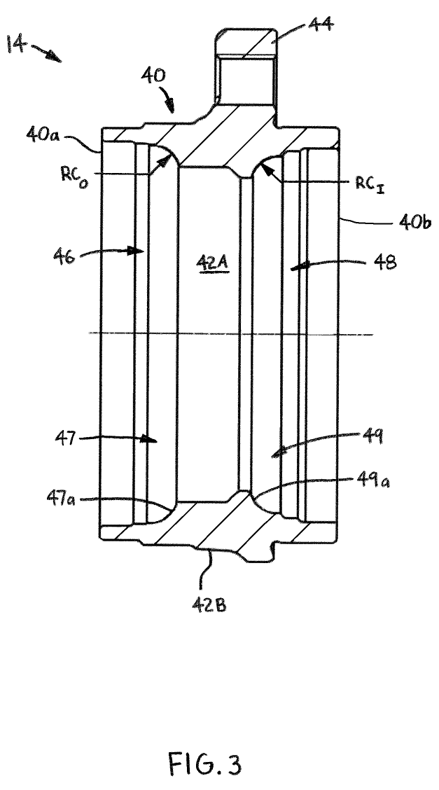

Referring now to FIG. 3, the outer ring 14 is configured to connect with the vehicle 2 and includes a generally circular cylindrical body 40 with an outboard axial end 40a, an opposing inboard axial end 40b, an inner circumferential surface 42A and an opposing outer circumferential surface 42B. Preferably, the outer ring body 40 has at least one and preferably a plurality of flanges 44 (only one shown) each extending radially outwardly from the outer circumferential surface 42B, each outer ring flange 44 being configured to connect with a steering knuckle or a suspension component 3 (FIG. 1) by means of threaded fasteners (none shown).

Further, the outer ring body 40 has an outboard outer raceway 46 and an inboard outer raceway 48 spaced axially from the outboard outer raceway 46, each outer raceway 46, 48 being formed on the body inner circumferential surface 42A. When the outer ring 14 is disposed about the hub 12, the outboard end 40a of the ring 14 is disposed adjacent to the hub flange 26, the ring inboard end 40b is disposed adjacent to the hub inboard end 24b, the outboard outer raceway 46 is disposed about the inboard inner raceway 28 and the outboard outer raceway 48 is disposed about the inboard inner raceway 30.

Preferably, the outboard outer raceway 46 is formed as first concave annular groove 47 extending radially outwardly from the inner circumferential surface 42A of the outer ring cylindrical body 40. Similarly, the inboard outer raceway 48 is preferably formed as a second concave annular groove 49 extending radially outwardly from the inner circumferential surface 42B of the body 40 and spaced axially from the first groove 47. As discussed above with the hub 12, the concave annular grooves 47, 49 of the outer raceways 46, 48, respectively, are each configured to receive rolling elements 18, 22 that are formed as balls 19, 23, respectively. However, one or both of the outer raceways 46, 48 may alternatively be formed to receive cylindrical rollers, tapered rollers, etc. and matching a similar inner raceway 28, 30. Furthermore, each concave annular groove 47, 49 of the outer ring 14 preferably has a radial section 47a, 49a, respectively, and are formed such that the radial section 47a of the outboard concave annular groove 47 faces toward the outer ring outboard end 40a and the radial section 49a of the inboard concave annular groove 49 faces toward the outer ring inboard end 40b. As such, the rolling elements 18, 22 are generally arranged in an O-type configuration when disposed on the outboard raceway pairs 28/46 and the inboard raceway pairs 30/48, as is generally known in the field of angular contact bearings.

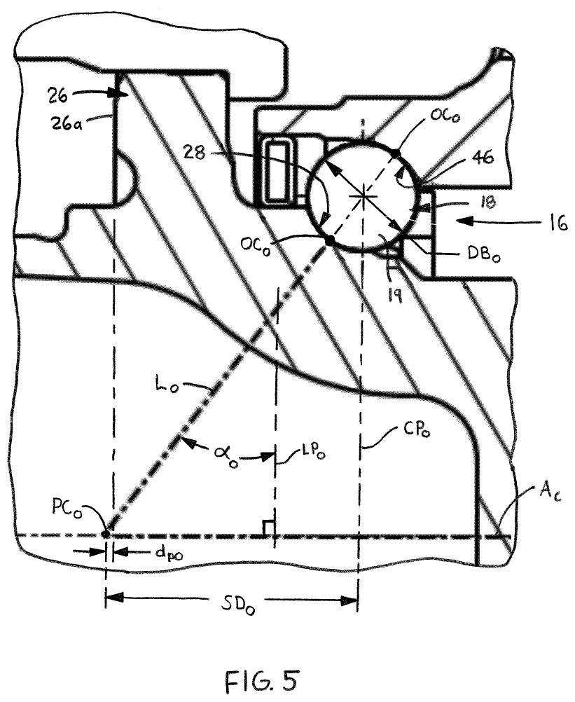

Referring to FIGS. 1-5, the outboard set 16 of rolling elements 18 are disposed between the outboard inner raceway 28 and the outboard outer raceway 46 and are spaced circumferentially about the central axis A_{C}. As such, the outboard rolling elements 18 are simultaneously rollable along the outboard raceways 28, 46 when the hub 12 rotates about the central axis A_{C} so as to traverse a theoretical outboard pitch circle CP_{O} extending through the geometric center of all of the rolling elements 18, the pitch circle CP_{O} having an outboard pitch diameter DP_{O}, as indicated in FIG. 1. With the preferred rolling elements 18 being balls 19, each outboard concave annular groove 29, 47 has a radius of curvature RC_{O} (FIGS. 2 and 3) and each ball 19 of the outboard set 16 has a diameter DB_{O} (FIG. 5) and are each relatively sized such that a ratio between the radius of curvature RC_{O} of each groove 29, 47 and the diameter DB_{O} of each ball 19 is between 0.5175 and 0.539.

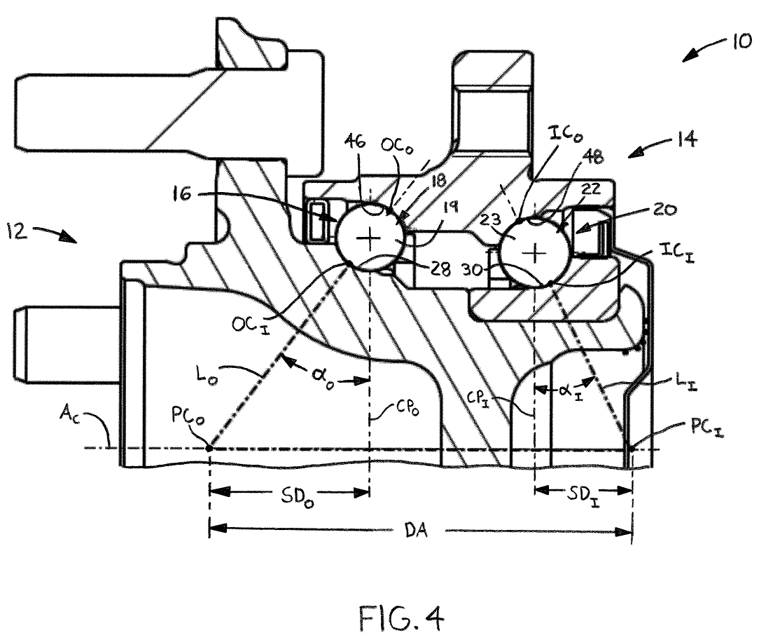

As best shown in FIGS. 4 and 5, the outboard raceways 28, 46 are configured such that each rolling element 18 of the outboard set 16 contacts the outboard inner raceway 28 at an inner contact point OC_{I} and simultaneously contacts the outboard outer raceway 46 at an outer contact point OC_{O}. Each line L_{O} extending through the inner and outer contact points OC_{I}, OC_{O} of an outboard rolling element 18 defines an outboard contact angle α_{O} with any line LP_{O} perpendicular to the central axis A_{C}. Also, each line L_{O} extending through the inner and outer contact points OC_{I}, OC_{O} of each outboard rolling element 18 intersects the central axis A_{C} at an outboard pressure center PC_{O}. Furthermore, the outboard pressure center PC_{O} is spaced axially from the outboard pitch circle CP_{O} by an outboard pressure center spacing distance SD_{O}.

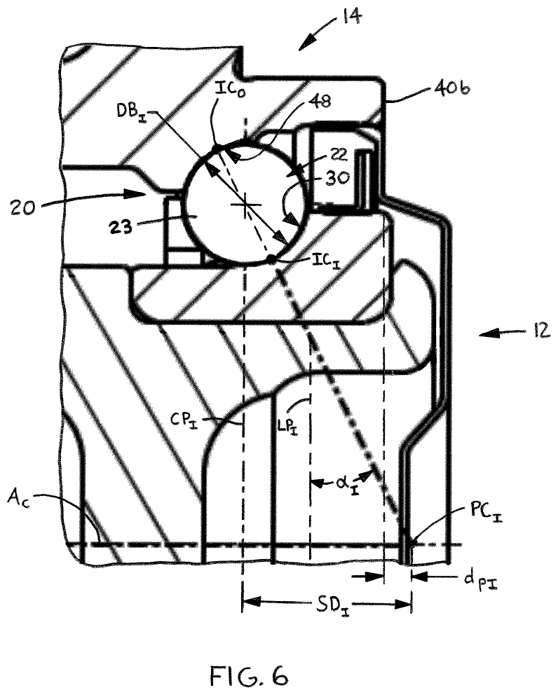

Referring to FIGS. 1-4 and 6, the inboard set 20 of rolling elements 22 are disposed between the inboard inner raceway 30 and the outboard outer raceway 48 and are spaced circumferentially about the central axis A_{C}. As such, the inboard rolling elements 22 are simultaneously rollable along the inboard raceways 30, 48 when the hub 12 rotates about the central axis A_{C} so as to traverse a theoretical inboard pitch circle CP_{I} through the geometric center of all of the rolling elements 22, the inboard pitch circle CP_{I} having an inboard pitch diameter DP_{I}. With the preferred rolling elements 22 being balls 23, each inboard concave annular groove 31, 49 has a radius of curvature RC_{I} (FIGS. 2 and 3) and each ball 23 of the inboard rolling element set 20 has a diameter DB_{I} (FIG. 6) and are each relatively sized such that a ratio between the radius of curvature RC_{I} of each groove 31, 49 and the diameter DB_{I} of each ball 23 is between 0.5175 and 0.529. Preferably, each ball 19 and each ball 23 is sized such that the diameters DB_{O} and DB_{I} are equal, but alternatively, the balls 19 and 23 may be of unequal or different sizes.

As best shown in FIGS. 4 and 6, the inboard raceways 30, 48 are configured such that each rolling element 22 of the inboard set 20 contacts the inboard inner raceway 30 at an inner contact point IC_{I} and simultaneously contacts the inboard outer raceway 48 at an outer contact point IC_{O}. Any line L_{I} extending through the inner and outer contact points IC_{I}, IC_{O} of an inboard rolling element 22 defines an inboard contact angle α_{I} with any line LP_{I} perpendicular to the central axis A_{C}, as indicated in FIG. 6. Also, each line L_{I} extending through the inner and outer contact point IC_{I}, IC_{O} of each inboard rolling element 22 intersects the central axis A_{C} at an inboard pressure center PC_{I}. Furthermore, the inboard pressure center PC_{I} is spaced axially from the inboard pitch circle CP_{I} by an inboard pressure center spacing distance SD_{I}.

Having described the basic structure above, certain features of the hub bearing unit 10 of the present invention which improve the performance thereof are now discussed. Specifically, to optimize the performance of the wheel hub bearing unit 10, the hub 12 and the outer ring 14 are formed or constructed to position the rolling elements 18, 22 in a manner that has been determined to best balance considerations of friction on the rolling elements 18, 22 and the stiffness, mass and fatigue life of the hub bearing unit 10.

First, the outboard inner and outer raceways 28, 46, respectively, and each outboard rolling element 18 are sized relative to the inboard inner and outer raceways 30, 48 and each inboard rolling element 22 such that the outboard pitch diameter DP_{O} is at least five millimeters (5 mm) greater, or at least seven and one-half percent (7.5%) greater, than the inboard pitch diameter DP_{I}. Such an asymmetrical structure of the two rolling element rows 16, 20 increases an axial distance DA (FIG. 4) between the inboard pressure center PC_{I} and the outboard pressure center PC_{O} independently of the actual values of the contact angles α_{O}, α_{I}.

To further maximize stiffness, the outboard raceways 28, 46 and the outboard rolling elements 18 are formed and sized such that the outboard contact angle α_{O} has a value of at least thirty-four degrees (34°). With such a relatively large value of the outboard angle α_{O}, the outboard pressure center PC_{O} is shifted axially away from the inboard pressure center PC_{I}, which increases stiffness in the hub bearing unit 10. Preferably, the outboard pressure center PC_{O} is spaced axially from the outboard axial end 26a of the flange 26 by a distance d_{PO} of no greater than one and one-half millimeters (1.5 mm), most preferably outwardly from the axial end 26a as shown in FIG. 5.

Then, to increase stiffness with minimal impact on or increase of friction within the hub bearing unit 10, the inboard contact angle α_{I} is adjusted or established relative to the outboard contact angle α_{O} so as to ideally locate the inboard pressure center PC_{I}. Specifically, the inboard raceways 30, 48 and the inboard rolling elements 22 are formed and sized such that the inboard contact angle α_{I} has a value within a range of forty-five percent (45%) and seventy-five percent (75%) of the value of the outboard contact angle α_{O}. With such relative sizing of the contact angles α_{O}, α_{I}, the inboard pressure center spacing distance SD_{I} has a value within a range of fifty percent (50%) and seventy percent (70%) of a value of the outboard pressure center spacing distance SD_{O}. Further, the inboard pressure center PC_{I} is preferably axially spaced from the inboard axial end 40b of the outer ring 14 by a distance d_{PI} of no greater than three millimeters (3 mm), most preferably outwardly from the axial end 40b as depicted in FIG. 6.

With the above combination of the relative sizing of the outboard and inboard pitch diameters DP_{O}, DP_{I} and the relative values of the outboard and inboard contact angles α_{O}, α_{I}, the present hub bearing unit 10 has a desired amount of stiffness with a relatively lower amount of friction in comparison with previous hub bearing units. In particular, the friction of the present hub bearing unit 10 is substantially less and has a similar amount of stiffness in comparison with previous hub bearing units which increased preload on the rolling elements to increase stiffness.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A hub bearing unit for rotatably coupling a wheel with a vehicle, the wheel being rotatable about a central axis, the hub bearing unit comprising:
a hub rotatable about the central axis and having an outboard axial end, an inboard axial end, a flange extending radially outwardly from a remainder of the hub at least generally adjacent to outboard axial end and configured to mount the wheel to the hub, an outboard inner raceway and an inboard inner raceway spaced axially from the outboard inner raceway;
an outer ring disposed about the hub and configured to connect with the vehicle, the outer ring having an outboard outer raceway and an inboard outer raceway spaced axially from the outboard outer raceway;
an outboard set of rolling elements disposed between the outboard inner raceway and the outboard outer raceway so as to traverse an outboard pitch circle having a pitch diameter, each rolling element of the outboard set of rolling elements contacting the outboard inner raceway at an inner contact point and contacting the outboard outer raceway at an outer contact point, a line extending through the inner and outer contact points defining an outboard contact angle with a line perpendicular to the central axis; and
an inboard set of rolling elements disposed between the inboard inner raceway and the inboard outer raceway so as to traverse an inboard pitch circle having an inboard pitch diameter, the outboard pitch diameter being at least five millimeters greater than the inboard pitch diameter, and each rolling element of the inboard set of rolling elements contacting the inboard inner raceway at an inner contact point and contacting the inboard outer raceway at an outer contact point, a line extending through the inner and outer contact points defining an inboard contact angle with a line perpendicular to the central axis;
wherein the outboard contact angle has a value of at least thirty-four degrees and the inboard contact angle has a value within a range of forty-five percent and seventy-five percent of the value of the outboard contact angle.

2. The hub bearing unit as recited in claim 1, wherein:
each line extending through the inner contact point and the outer contact point of each rolling element of the outboard set of rolling elements intersects the central axis at an outboard pressure center, the outboard pressure center being spaced axially from the outboard pitch circle by an outboard pressure center spacing distance; and
each line extending through the inner contact point and the outer contact point of each rolling element of the inboard set of rolling elements intersects the central axis at an inboard pressure center, the inboard pressure center being spaced axially from the inboard pitch circle by an inboard pressure center spacing distance, the inboard pressure center spacing distance having a value within a range of fifty percent and seventy percent of a value of the outboard pressure center spacing distance.

3. The hub bearing unit as recited in claim 2, wherein:
the flange of the hub has an outboard axial end and an inboard axial end, the outboard pressure center being spaced axially from the outboard axial end of the flange by a distance of no greater than one and one-half millimeters (1.5 mm); and
the inboard pressure center is axially spaced from the inboard axial end of the outer ring by a distance of no greater than three millimeters (3 mm).

4. The hub bearing unit as recited in claim 1, wherein the value of the outboard pitch circle diameter is at least seven and one-half percent (7.5%) greater than the value of the inboard pitch circle diameter.

5. The hub bearing unit as recited in claim 1 wherein:
each one of the outboard inner raceway and the inboard inner raceway is formed as a concave annular groove extending radially inwardly from an outer circumferential surface of the hub;
each one of the outboard outer raceway and the inboard outer raceway is formed as a concave annular groove extending radially outwardly from an inner circumferential surface of the outer ring; and
each rolling element of the outboard set of rolling elements and each rolling element of the inboard set of rolling elements is a ball.

6. The hub bearing unit as recited in claim 5 wherein:
each concave annular groove of the hub has a radial section, the radial section of the concave annular groove of the outboard inner raceway facing toward the inboard end of the hub and the radial section of the concave annular groove of the inboard inner raceway facing toward the outboard end of the hub; and
each concave annular groove of the outer ring has a radial section, the radial section of the concave annular groove of the outboard outer raceway facing toward the outboard end of the hub and the radial section of the concave annular groove of the inboard outer raceway facing toward the inboard end of the hub.

7. The hub bearing unit as recited in claim 5 wherein:
each one of the concave annular grooves of the outboard inner raceway and the outboard outer raceway has a radius of curvature and each ball of the outboard set of rolling elements has a diameter, a ratio between the radius of curvature of each concave annular groove of the outboard inner raceway and the outboard outer raceway and the diameter of each ball is between 0.5175 and 0.539; and
each one of the concave annular grooves of the inboard inner raceway and the inboard outer raceway has a radius of curvature and each ball of the outboard set of rolling elements has a diameter, a ratio between the radius of curvature of each concave annular groove of the inboard inner raceway and the inboard outer raceway and the diameter of each ball is between 0.5175 and 0.529.

8. The hub bearing unit as recited in claim 1, wherein the hub has a cylindrical main body portion including the annular flange and an annular ring disposed about the main body portion adjacent to the inboard axial end, the annular ring having an outer circumferential surface and a concave annular groove extending radially inwardly from the outer circumferential surface and providing the inboard inner raceway.

9. The hub bearing assembly as recited in claim 1, wherein the outer ring has an outer circumferential surface and at least one flange extending radially outwardly from the outer circumferential surface, the at least one flange of the outer ring being configured to connect with a steering knuckle or a suspension component.
